(19) United States
(12) Patent Application Publication
(10) Pub. No.: US 2005/0221265 A1
(43) Pub. Date: Oct. 6, 2005

(54) Method to assess a person's knowledge of a subject area

(76) Inventors: Jay Shiro Tashiro, Tucson, AZ (US); Darren R. Choate, Tucson, AZ (US)

Correspondence Address: Dale F. Regelman;Law Office of Dale F. Regelman, P.C., 4231 S. Fremont Avenue4, Tucson, AZ, 85714, US

(21) Appl. No.: 11/097,523

(22) Filed: Mar. 31, 2005

Related U.S. Application Data
(60) Provisional application No. 60/521,329, filed on Apr. 1, 2004.

(51) Int. Cl. G09B 7/00

(52) U.S. Cl. 434/322

(57) ABSTRACT

A method to assess a person's knowledge of a subject area is disclosed. The method prepares a plurality of test questions relating to the subject area, selects (n) first test questions from that plurality of test questions, and propounding each of these first test questions to the subject. The subject answers zero or more of the propounded first test questions. The method then determines for each of the propounded first test questions if that first test question was correctly answered, calculates a first score by dividing the number of correctly answered first questions by (n), sets an Excellent Threshold and an Excellent Points Assignment, and determines if the first score is greater than or equal to that Excellent Threshold. If the first score is greater than or equal to the Excellent Threshold, the method allocates the Excellent Points Assignment and assigns an End Of Pathway designation of Excellent.

This Application claims priority from a U.S. Provisional Application having Ser. No. 60/521,329.

### FIELD OF THE INVENTION

The invention relates to a method to assess a person's knowledge about a subject area.

### BACKGROUND OF THE INVENTION

Education modernly lacks a method to provide real-time assessment of the multiple dimensions of a student's progress as he/she attempts to master a particular subject or topic. Using prior art methods, a teacher/professor/facilitator provides feedback to the student after the student completes an assignment, lab session, examination, and the like.

Due to the sheer number of students participating in a class, lab session, or project, and the concomitant workload associated therewith, as well as the multiple dimensions of what a student has learned, a student does not receive feedback relating to his/her progress for an extended period of time. What is needed is an adaptive testing method that continuously assesses the student's progress in real-time, where that method provides a more immediate analysis of the performance by way of real-time feedback and accounts for the multiple dimensions of learning inherent in both levels of complexity of knowledge and within each level of relevant categories.

### SUMMARY OF THE INVENTION

Applicants' invention comprises a method to assess a person's knowledge of a subject area. The method prepares a plurality of test questions relating to a selected knowledge level of the subject area, selects (n) first test questions from that plurality of test questions, and propounds each of these first test questions to the subject. The subject answers zero or more of the propounded first test questions.

The method then determines for each of the propounded first test questions if that first test question was correctly answered, calculates a first score by dividing the number of correctly answered first questions by (n), sets an Excellent Threshold, sets an Excellent Points Assignment and determines if the first score is greater than or equal to that Excellent Threshold. If the first score is greater than or equal to the Excellent Threshold, the method allocates the Excellent Points Assignment to the selected knowledge level and assigns an End Of Pathway designation of Excellent to that selected knowledge level.

If the first score is not greater than or equal to the Excellent Threshold, then the method selects (q) second test questions at the selected knowledge level from the plurality of test questions and propounds each of those second test questions to the subject. The subject provides answers to zero or more of the second test questions.

The method then sets a Good Threshold, a Good-Pass Threshold, a Poor-Pass Threshold, a Good-Pass Points Assignment, a Good-Fail Points Assignment, a Poor-Pass Points Assignment, and a Poor-Fail Points Assignment and determines for each of the propounded second test questions if that second test question was correctly answered, and calculates a second score by dividing the number of correctly answered second questions by (q). If the first score is less than the Excellent Threshold and greater than the Good Threshold, and if the second score is greater than or equal to the Good-Pass Threshold, the method allocates the Good-Pass Points Assignment to the selected knowledge level and assigns an End Of Pathway designation of Good-Pass to that selected knowledge level.

If the first score is less than the Excellent Threshold and greater than the Good Threshold, and if the second score is not greater than or equal to the Good-Pass Threshold, the method allocates the Good-Fail Points Assignment to the selected knowledge level and assigns an End Of Pathway designation of Good-Fail to that selected knowledge level. If the first score is less than the Good Threshold, and if the second score is greater than or equal to the Poor-Pass Threshold, the method allocates the Poor-Pass Points Assignment, to the selected knowledge level and assigns an End Of Pathway designation of Poor-Pass to that selected knowledge level. If the first score is less than the Good Threshold, and if the second score is not greater than or equal to the Poor-Pass Threshold, the method allocates the Poor-Fail Points Assignment to the selected knowledge level and assigns an End Of Pathway designation of Poor-Fail to that selected knowledge level.

### BRIEF DESCRIPTION OF THE DRAWINGS

The invention will be better understood from a reading of the following detailed description taken in conjunction with the drawings in which like reference designators are used to designate like elements, and in which:

FIG. 1 is a flow chart summarizing certain initial steps in Applicants' method;

FIG. 2 is a flow chart summarizing certain additional steps in Applicants' method;

FIG. 3 is a flow chart summarizing certain additional steps in Applicants' method;

FIG. 4 is a flow chart summarizing certain additional steps in Applicants' method;

FIG. 5 is a flow chart summarizing certain additional steps in Applicants' method;

FIG. 6A is a block diagram showing a first embodiment of Applicants' apparatus used to perform Applicants' method; and

FIG. 6B is a block diagram showing a first embodiment of Applicants' apparatus used to perform Applicants' method.

### DETAILED DESCRIPTION OF THE PREFERRED EMBODIMENTS

This invention is described in preferred embodiments in the following description with reference to the Figures, in which like numbers represent the same or similar elements.

Applicants' method initiates a testing sequence based on “levels of complexity” of which the student must progress and within each level relevant categories that a student must address. This testing sequence assesses the student's mastery of the subject area. Based on the result of the testing sequence, where the testing sequence consists of one or more questions, with each level, the invention provides analysis of performance and feedback.

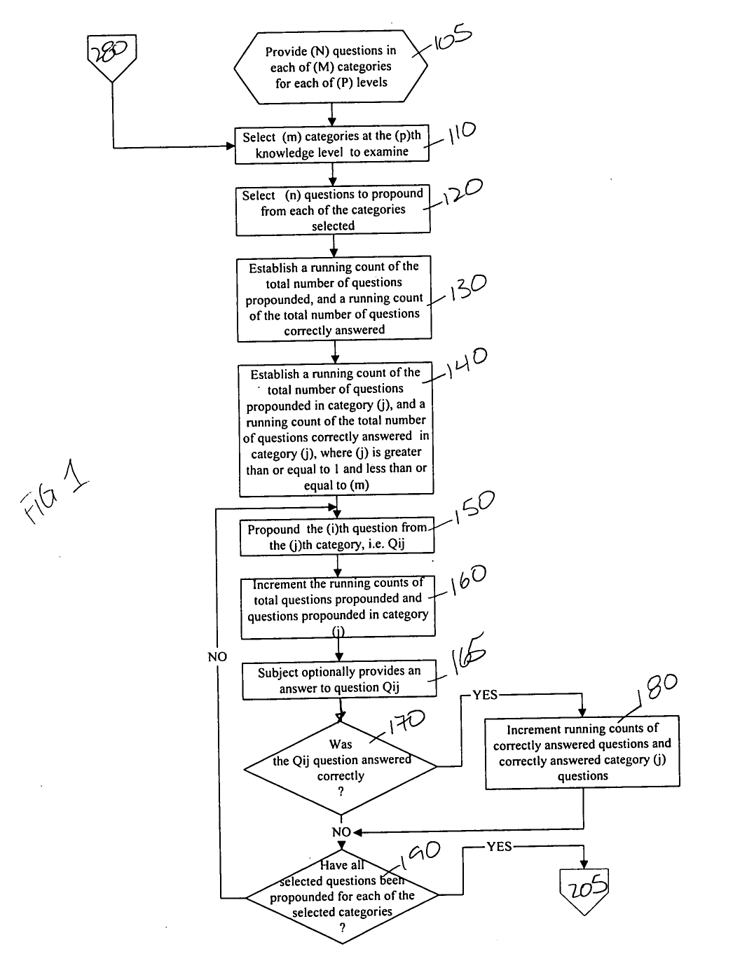

FIGS. 1 through 5 summarize the steps of Applicants' method to assess a person's knowledge of a subject area. Referring now to FIG. 1, in step 105 Applicants' method provides a plurality of questions in one or more categories for each of one or more knowledge levels relating to a selected subject area. If the subject area comprises chemistry, for example, one category of knowledge may comprise, for example organic chemistry, a second category may comprise inorganic chemistry, a third category may comprise biochemistry, a fourth category may comprise physical chemistry, and so on.

A first knowledge level regarding the subject may comprise, for example, chemical nomenclature, a familiarity with the periodic table of the elements, and the like. A second knowledge level may comprise synthetic chemistry including the methods and apparatus used to prepare certain organic/inorganic/biochemical compositions. A third knowledge level may comprise analytical techniques including the methods and apparatus used to identity certain organic/inorganic/biochemical compositions.

In certain embodiments, step 105 comprises providing (N) questions in each of (M) categories for each of (P) levels, wherein (N), (M), and (P) are each greater than or equal to 2. In certain embodiments, step 105 comprises providing (N1) questions for a first category (M1), (N2) questions for a second category (M2), and so on. In certain embodiments, step 105 comprises providing (N11) questions for a first category (M1) at a first level of knowledge, (N12) questions for that first category at a second level of knowledge, and so on.

In certain embodiments, step 105 further comprises creating the above-described (N), (N1), (N2), (N11), (N21) questions. In other embodiments, step 105 further comprises selecting the above-described (N), (N1), (N2), (N11), (N21) questions from previously created test questions.

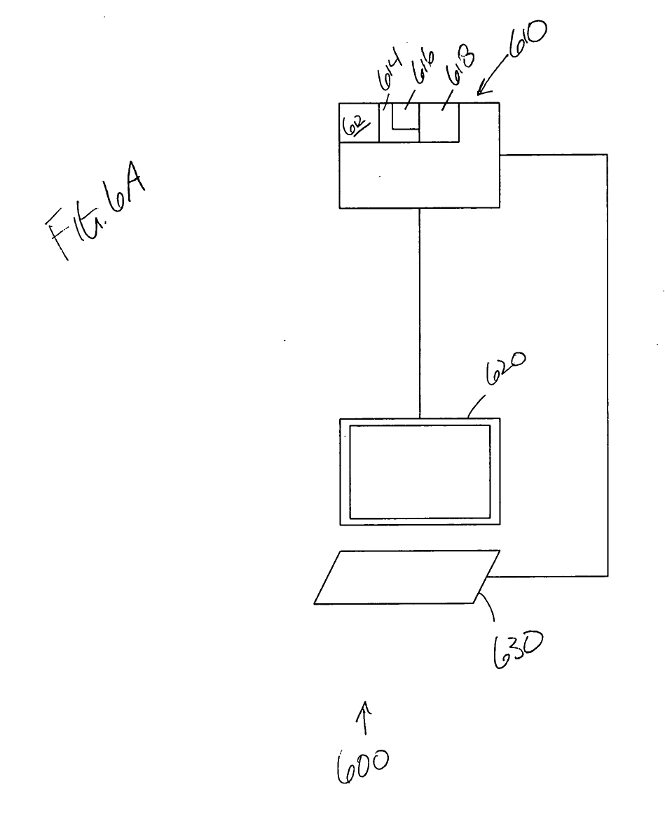

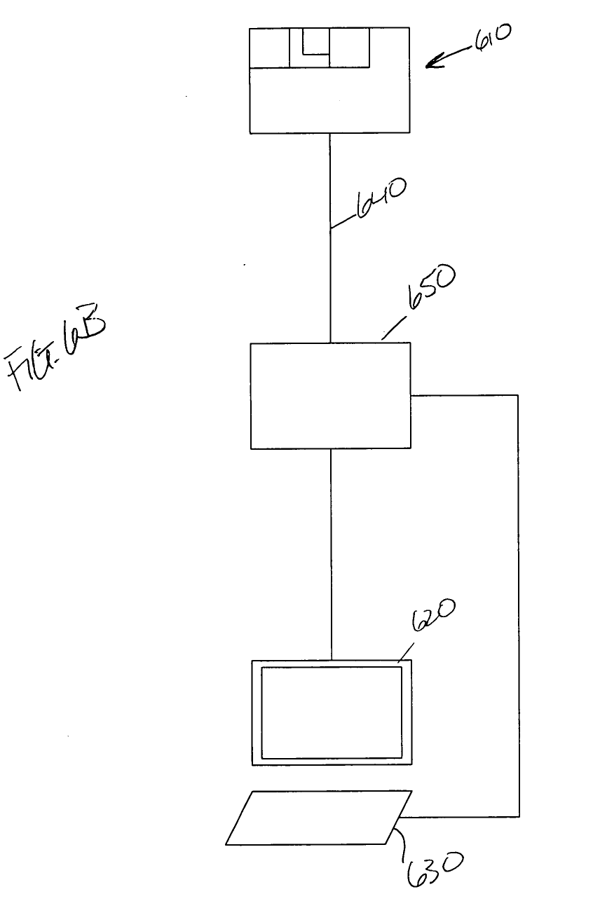

In step 110, Applicants' method selects (m) categories of knowledge at the (p)th knowledge level to test. In certain embodiments, step 110 is performed by a natural person administering an examination to a subject. In other embodiments, step 110 is performed by a computing device, such as computing device 610 (FIGS. 6A, 6B), using a pre-determined algorithm, such as instructions 616 (FIG. 6A). In still other embodiments, step 110 is performed by the subject taking the examination.

In step 120, Applicants' method selects (n) questions from the plurality of questions of step 105 to propound to the subject. In certain embodiments, step 120 further comprises randomly selecting the (n) questions. In certain embodiments, step 120 further comprises selecting from the plurality of questions of step 105 a total of (nj) questions for the (j)th category, such as (n1) questions from a first category, and (n2) questions from a second category, (n3) questions from a third category, and so on. In certain embodiments, step 120 is performed by a natural person. In other embodiments, step 120 is performed by a computing device. In still other embodiments, step 120 is performed by the subject taking the examination.

In step 130, Applicants' method establishes and maintains a running count for the total number of questions propounded, and for the total number of questions answered correctly. In certain embodiments step 130 comprises initializing to 0 the number of total number of questions propounded, i.e. the variable Qtot, and initializing to 0 the total number of propounded questions answered correctly, i.e. the variable Ctot. In certain embodiments, step 130 is performed by a natural person. In other embodiments, step 130 is performed by a computing device.

In step 140, Applicants' method establishes and maintains a running count of the number of questions propounded in each of the selected categories, and establishes and maintains a running count for the number of correctly answered questions in each of the selected categories. In certain embodiments, step 140 comprises initializing to 0, for each value of (j), the number of questions Qj propounded in a certain category (j), and initializing to 0 the total number of correctly answered propounded questions Cj in a certain category (j), where (j) is greater than or equal to 1 and less than or equal to (m). In certain embodiments, step 140 is performed by a natural person. In other embodiments, step 140 is performed by a computing device.

In step 150, Applicants' method propounds question Qij comprising the (i)th question from the (j)th category to the subject, wherein (i) is greater than or equal to 1 and less than or equal to (n). In certain embodiments, step 150 is performed by a natural person administering an examination to a subject. In other embodiments, step 150 is performed by a computing device.

Referring now to FIG. 6A, in certain embodiments step 150 further comprises providing a first computing device, such as computing device 610 (FIGS. 6A, 6B) comprising an information storage medium, such as information storage medium 614 (FIG. 6A), and an information display device, such as information display device 620 (FIGS. 6A, 6B), wherein the questions selected in step 120 are stored in the information storage medium, and wherein step 150 further comprises displaying question Qij on the information display device. In certain embodiments, that information display device is interconnected with the first computing device. In certain embodiments, the first computing devices comprises a mainframe computer, personal computer, workstation, and combinations thereof, including an operating system, such as operating system 618, comprising, without limitation, Windows, Unix, LINUX, and the like. (Windows is a registered trademark of Microsoft Corporation; UNIX is a registered trademark in the United States and other countries licensed exclusively through The Open Group; LINUX is a trademark owned by Linus Torvalds.) Referring now to FIG. 6B, in other embodiments the information display device 620 is interconnected to a second computing device 650, where that second computing device 650 is interconnected with the first computing device 610 via one or more communication links 640. In certain embodiments, the second computing device 650 comprises a mainframe computer, personal computer, workstation, and combinations thereof, including an operating system such as without limitation Windows, Unix, LINUX, and the like. (Windows is a registered trademark of Microsoft Corporation; UNIX is a registered trademark in the United States and other countries licensed exclusively through The Open Group; LINUX is a trademark owned by Linus Torvalds.) Those one or more communication links 640 are each selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, the one or more communication links are compliant with one or more of the embodiments of IEEE Specification 802.11 (collectively the “IEEE Specification”). As those skilled in the art will appreciate, the IEEE Specification comprises a family of specifications developed by the IEEE for wireless LAN technology.

Referring once again to FIG. 1, in step 160, Applicants' method increments the running count of total questions propounded, and the running count of the questions propounded in the (j)th category. In certain embodiments, step 160 comprises setting Qtot equal to (Qtot+1), and setting Qj equal to (Qj+1).

In certain embodiments, step 160 is performed by a natural person. In other embodiments, step 160 is performed by a computing device. In certain embodiments, step 160 is performed substantially synchronously with step 150. By “substantially synchronously,” Applicants mean that step 160 is performed within about 1 second after completing step 150.

In step 165, the subject provides an answer to the propounded question of step 150. In certain embodiments, Applicants' method waits a designated time interval for the subject to provide an answer to the propounded test question. If no answer is received within that time interval, Applicants' method transitions to step 170 and determines that the propounded question was not correctly answered.

In certain embodiments, step 165 further comprises providing a data input device, such as data input device 630 (FIGS. 6A, 6B) interconnected with the first computing device, or optionally the second computing device, described above. In certain embodiments, that data input device comprises a keyboard, a pointing device, a mouse, combinations thereof, and the like. In these data input device embodiments, step 165 further comprises receiving an answer to the propounded questions of step 150 via the data input device.

In step 170, Applicants' method determines if the Qij question was answered correctly. In certain embodiments, step 170 is performed by a natural person. In other embodiments, step 170 is performed by a computing device.

If Applicants' method determines in step 170 that the Qij question was answered correctly, then the method transitions from step 170 to step 180 wherein the method increments the running count for total correctly answered questions, and increments the running count for correctly answered questions in the (j)th category. In certain embodiments, step 170 is performed by a natural person administering an examination to a subject. In other embodiments, step 170 is performed by a computing device. Applicants' method transitions from step 180 to step 190.

If Applicants' method determines in step 170 that the Qij question was not answered correctly, then the method transitions from step 170 to step 190 wherein the method determines if all the questions selected in step 120 have been propounded. In certain embodiments, step 190 is performed by a natural person. In other embodiments, step 190 is performed by a computing device. In certain embodiments, steps 165, 170, optionally 180, and 190, are performed substantially synchronously.

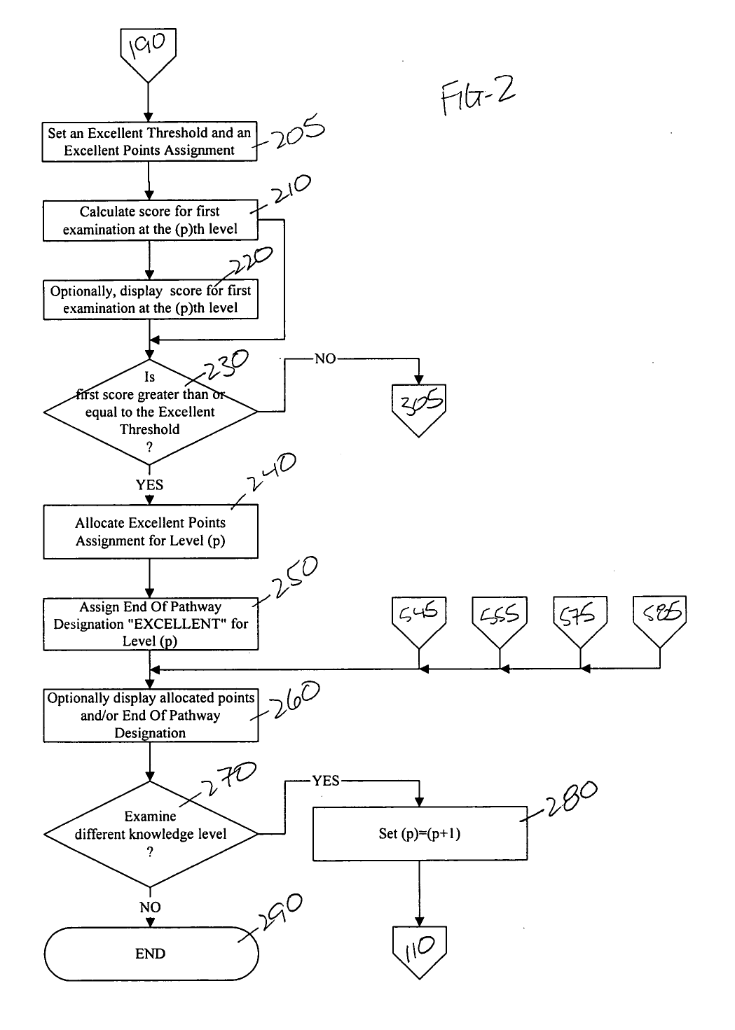

If Applicants' method determines in step 190 that all the questions selected in step 120 have not been propounded, then the method transitions from step 190 to step 150 and continues as described herein. Alternatively, if Applicants' method determines in step 190 that all the questions selected in step 120 have been propounded, then the method transitions from step 190 to step 205 (FIG. 2).

Referring now to FIG. 2, in step 205 Applicants' method sets an Excellent Threshold and Excellent Points Assignment. In certain embodiments, the Excellent Threshold is set at 0.80. In other embodiments, the Excellent Threshold is set at 0.75. In still other embodiments, the Excellent Threshold is set at 0.70. In yet other embodiments, that Excellent Threshold is set to a value less than 0.70.

In certain embodiments, the Excellent Points Assignment is set to 20 points. In certain embodiments, the Excellent Points Assignment is set to a value greater than 20 points. In certain embodiments, the Excellent Points Assignment is set to a value less than 20 points.

In certain embodiments, step 205 is performed by a natural person. In other embodiments, step 205 is performed by a computing device. Step 205 may be performed at any time prior to performing step 230.

In step 210, Applicants' method calculates a first score by dividing the total number of correctly answered in step 165 questions by the total number of questions propounded in step 150. In certain embodiments, step 210 comprises setting a score S1p, wherein (p) comprises the (p)th level selected in step 110, to Ctot/Qtot. In certain embodiments, step 210 is performed by a natural person. In other embodiments, step 210 is performed by a computing device. In certain embodiments, step 210 is performed substantially synchronously with the determination in step 190 that all the questions selected in step 120 have been propounded.

In certain embodiments, Applicants' method transitions from step 210 to step 220 wherein Applicants' method displays on an information display device the score calculated in step 210. In certain embodiments, step 210 is performed by a natural person. In other embodiments, step 210 is performed by a computing device. In certain embodiments, steps 210 and 220 are performed substantially synchronously. Applicants' method transitions from step 220 to step 230.

In certain embodiments, Applicants' method transitions from step 210 to step 230 wherein the method determines if the score calculated in step 210 is greater than or equal to the Excellent Threshold of step 205. In certain embodiments, step 230 is performed by a natural person. In other embodiments, step 230 is performed by a computing device. In certain embodiments, steps 210 and 230 are performed substantially synchronously. In certain embodiments, steps 210, 220, and 230, are performed substantially synchronously.

If Applicants' method determines in step 230 that the score calculated in step 210 is greater than or equal to the Excellent Threshold, then the method transitions from step 230 to step 240 wherein the method allocates the Excellent Points Assignment for the (p)th level. In certain embodiments, step 240 is performed by a natural person. In other embodiments, step 240 is performed by a computing device.

Applicants' method transitions from step 240 to step 250 wherein the method assigns an End Of Pathway designation of EXCELLENT for the (p)th level. In certain embodiments, step 250 is performed by a natural person administering an examination to a subject. In other embodiments, step 250 is performed by a computing device.

In certain embodiments, Applicants' method transitions from step 250 to step 260 wherein the method displays on an information display device the End Of Pathway designation of step 250. In certain embodiments, step 260 is performed by a natural person administering an examination to a subject. In other embodiments, step 260 is performed by a computing device. In certain embodiments, steps 250 and 260 are performed substantially synchronously. In certain embodiments, steps 210, 220, 230, 240, 250, and 260, are performed substantially synchronously. Applicants' method transitions from step 260 to step 270.

In certain embodiments, Applicants' method transitions from step 250 to step 270 wherein the method determines whether to begin an examination at a higher knowledge level (p+1). In certain embodiments, step 270 is performed by a natural person. In other embodiments, step 270 is performed by a computing device. In certain embodiments, step 270 is performed by the subject taking the examination.

If Applicants' method elects not to begin a new examination at a different knowledge level, then the method transitions from step 270 to step 290 and ends. Alternatively, if Applicants' method elects to begin a new level of examination, then the method transitions from step 270 to step 280 wherein the method selects a different knowledge level from the level previously selected in step 110. In certain embodiments, step 280 comprises setting (p) equal to (p+1). In certain embodiments, step 280 is performed by a natural person. In other embodiments, step 280 is performed by a computing device. Applicants' method transitions from step 280 to step 110 and continues as described herein.

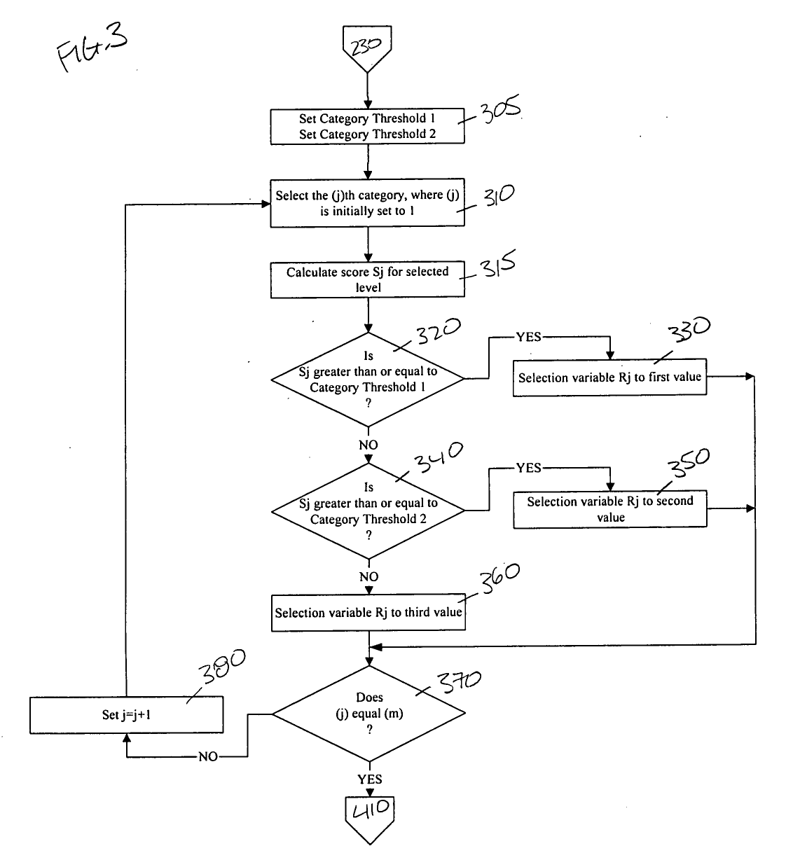

If Applicants' method determines in step 230 that the first test score is not greater than or equal to the Excellent Threshold set in step 205, then the method transitions from step 230 to step 305 (FIG. 3). If the score for the first examination is not greater than or equal to the Excellent Threshold, then Applicants' method conducts a second examination at the (p)th level of knowledge selected in step 110 (FIG. 1). In this second examination, the number of questions propounded in the (j)th category is based upon the score Sj achieved for that category in the first examination. After determining the score Sj, Applicants' method sets a selection variable Rj for the (j)th category. The number of questions Nj propounded in the second examination is the multiplication product of Rj and nj.

Referring now to FIG. 3, in step 305 Applicants' method sets a Category Threshold 1 and a Category Threshold 2. In certain embodiments, the Category Threshold 1 is set to 0.67. In certain embodiments, the Category Threshold 1 is set to a value greater than 0.67. In certain embodiments, the Category Threshold 1 is set to a value less than 0.67. In certain embodiments, the Category Threshold 2 is set to 0.67. In certain embodiments, the Category Threshold 2 is set to a value greater than 0.67. In certain embodiments, the Category Threshold 2 is set to a value less than 0.67.

In certain embodiments, step 305 is performed by a natural person. In other embodiments, step 305 is performed by a computing device. Step 305 may be performed at any time prior to performing steps 320 and/or 340.

In step 210, Applicants' method selects one of the categories of knowledge selected in step 110, i.e. the (j)th category wherein (j) is initially set to 1. In certain embodiments, step 310 is performed by a natural person. In other embodiments, step 310 is performed by a computing device.

Applicants' method transitions from step 310 to step 315 wherein the method calculates a score for the category selected in step 310. In certain embodiments, step 315 further comprises setting the score Sj for the (j)th category equal to the number of correctly answered questions relating to the selected category divided by the total number of propounded questions relating to the selected category, i.e. equal to Cj/Qj. In certain embodiments, step 315 is performed by a natural person. In other embodiments, step 315 is performed by a computing device. In certain embodiments, steps 310 and 315 are performed substantially synchronously.

Applicants' method transitions from step 315 to step 320 wherein the method determines if the category score of step 310, i.e. Sj, is greater than or equal to Category Threshold 1. In certain embodiments, step 320 is performed by a natural person. In other embodiments, step 320 is performed by a computing device.

If Applicants' method determines in step 320 that the category score of step 310 is greater than or equal to Category Threshold 1, then the method transitions from step 320 to step 330 wherein the method sets a selection variable to a first value. In certain embodiments, step 330 is performed by a natural person. In other embodiments, step 330 is performed by a computing device. In certain embodiments, step 330 comprises setting a variable Rj to 0. Applicants' method transitions from step 330 to step 370.

If Applicants' method determines in step 320 that the category score of step 310 is not greater than or equal to the Category Threshold 1, then the method transitions from step 320 to step 340 wherein the method determines if the category score of step 310 is greater than or equal to the Category Threshold 2. In certain embodiments, step 340 is performed by a natural person. In other embodiments, step 340 is performed by a computing device.

If Applicants' method determines in step 340 that the category score of step 310 is greater than or equal to the Category Threshold 2, then the method transitions from step 340 to step 350 wherein the method sets a selection variable to a second value. In certain embodiments, step 350 is performed by a natural person. In other embodiments, step 350 is performed by a computing device. In certain embodiments, step 350 comprises setting a variable Rj to 0.25. Applicants' method transitions from step 350 to step 370.

If Applicants' method determines in step 340 that the category score of step 310 is not greater than or equal to the Category Threshold 2, then the method transitions from step 340 to step 360 wherein the method sets a selection variable to a third value. In certain embodiments, step 360 is performed by a natural person. In other embodiments, step 360 is performed by a computing device. In certain embodiments, step 360 comprises setting a variable Rj to 0.5.

Applicants' method transitions from step 360 to step 370 wherein the method determines if scores for each of the categories selected in step 110 have been determined and examined, i.e. if (j) equals (m). In certain embodiments, step 370 is performed by a natural person. In other embodiments, step 370 is performed by a computing device.

If Applicants' method determines in step 370 that scores for each of the categories selected in step 110 have not been determined and examined, i.e. if (j) does not equal (m), then the method transitions from step 370 to step 380 wherein the method increments (j). In certain embodiments, step 380 comprises setting (j) equal to (j+1). In certain embodiments, step 380 is performed by a natural person. In other embodiments, step 380 is performed by a computing device. Applicants' method transitions from step 380 to step 310 and continues as described herein.

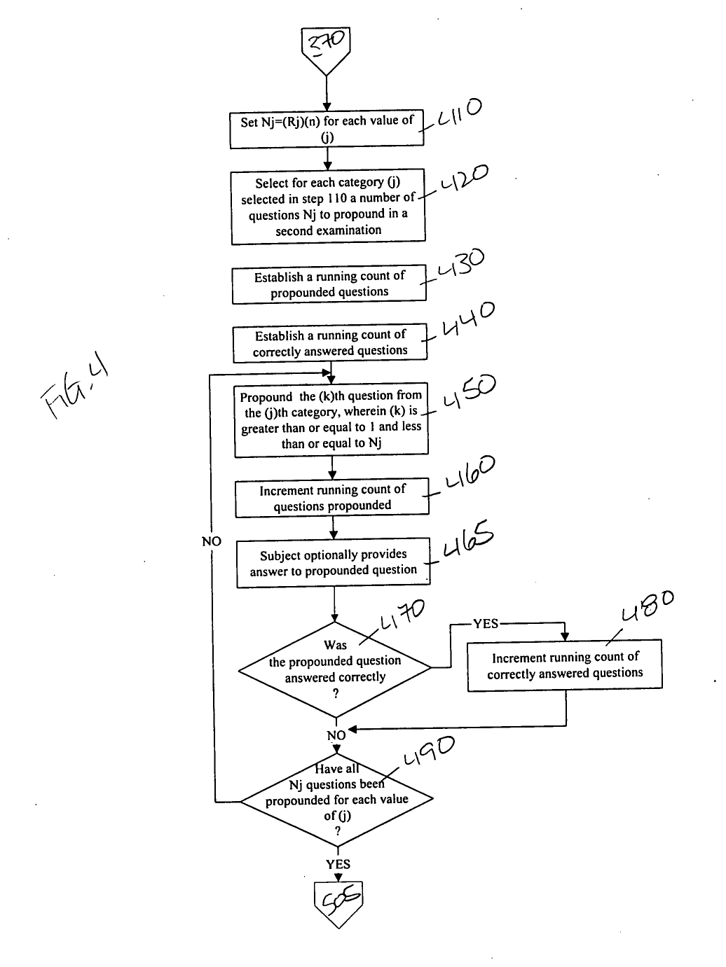

If Applicants' method determines in step 370 that scores for each of the categories selected in step 110 have been determined and examined, i.e. if (j) equals (m), then the method transitions from step 370 to step 410 (FIG. 4).

Referring now to FIG. 4, in step 410 Applicants' method selects the number of questions in each category to propound in a second round of examination at the (p)th knowledge level. In certain embodiments, step 410 is performed by a natural person. In other embodiments, step 410 is performed by a computing device. The number of questions to be propounded in a selected category is based upon the score for that category determined in step 310.

In certain embodiments, the number of questions to be propounded in a selected category is based upon the value of the each of the selection variables set in step 330, 350, or 360 for that selected category. In certain embodiments, step 410 comprises setting the number of questions Nj to be propounded in the (j)th category at the (p)th level to Rj times (n).

The following Example is presented to further illustrate to persons skilled in the art how to make the invention, and to identify one preferred embodiment thereof. This example is not intended as limitations, however, upon the scope of the invention which is defined by claims appended hereto.

### EXAMPLE

For example, if nj equals 4, i.e. if 4 questions in the (j)th category were propounded sequentially in step 150, and if 2 of those questions were answered correctly in step 165, and if the first score of step 210 is less than the Excellent Threshold, then in step 310 Applicants' method calculates a score Sj of 0.5 for the (j)th category, and in step 360 sets Rj to 0.5. In step 410 Applicants' method sets the number of questions from the (j)th category to propound in the second examination, i.e. variable Nj, equal to (0.5)(4) or 2. Thereafter in step 450, Applicants' method will propound 2 questions from the (j)th category in the second examination at the (p)th level.

Referring once again to FIG. 4, Applicants' method transitions from step 410 to step 420 wherein the method selects for the O)th category Nj questions to propound in the second examination. In certain embodiments, step 420 is performed by a natural person. In other embodiments, step 420 is performed by a computing device.

In step 430, Applicants' method establishes and maintains a running count of the total number of questions propounded in the second examination at the (p)th level. In certain embodiments, step 430 comprises initializing the total number of questions propounded in the second examination at the (p)th level to 0. In certain embodiments, step 430 comprises setting a variable Q to 0. In certain embodiments, step 430 is performed by a natural person. In other embodiments, step 430 is performed by a computing device.

In step 440, Applicants' method establishes and maintains a running count of the number of questions correctly answered in that second examination. In certain embodiments, step 440 comprises initializing the total number of questions answered correctly in the second examination to 0. In certain embodiments, step 440 comprises setting a variable C to 0. In certain embodiments, step 440 is performed by a natural person. In other embodiments, step 440 is performed by a computing device.

In step 450, Applicants' method propounds the (k)th question from the (j)th category, i.e. question Qkj, wherein (k) is greater than or equal to 1 and less than or equal to Nj. In certain embodiments, step 450 is performed using the apparatus and methods described hereinabove regarding step 150 (FIG. 1). In certain embodiments, step 450 is performed by a natural person. In other embodiments, step 450 is performed by a computing device.

In step 460, Applicants' method increments the running count of questions propounded. In certain embodiments, step 440 comprises setting Q equal to (Q+1). In certain embodiments, step 460 is performed by a natural person. In other embodiments, step 460 is performed by a computing device. In certain embodiments, step 460 is performed substantially synchronously with step 450.

In step 465, the subject optionally provides an answer to the propounded questions of step 450. In certain embodiments, step 465 utilizes the apparatus and methods described hereinabove with reference to step 165 (FIG. 1).

In step 470, Applicants' method determines if the question propounded in step 450 was answered correctly. In certain embodiments, step 470 comprises determining if Qkj was answered correctly. In certain embodiments, step 470 is performed by a natural person. In other embodiments, step 470 is performed by a computing device.

If Applicants' method determines in step 470 that the Qkj question was answered correctly, then the method transitions from step 470 to step 480 wherein the method increments the running count for correctly answered questions. In certain embodiments, step 480 comprises setting C equal to (C+1). In certain embodiments, step 470 is performed by a natural person. In other embodiments, step 470 is performed by a computing device. Applicants' method transitions from step 480 to step 490.

If Applicants' method determines in step 470 that the Qkj question was not answered correctly, then the method transitions from step 470 to step 490 wherein the method determines if all the questions selected in step 420 have been propounded. In certain embodiments, step 490 is performed by a natural person. In other embodiments, step 490 is performed by a computing device.

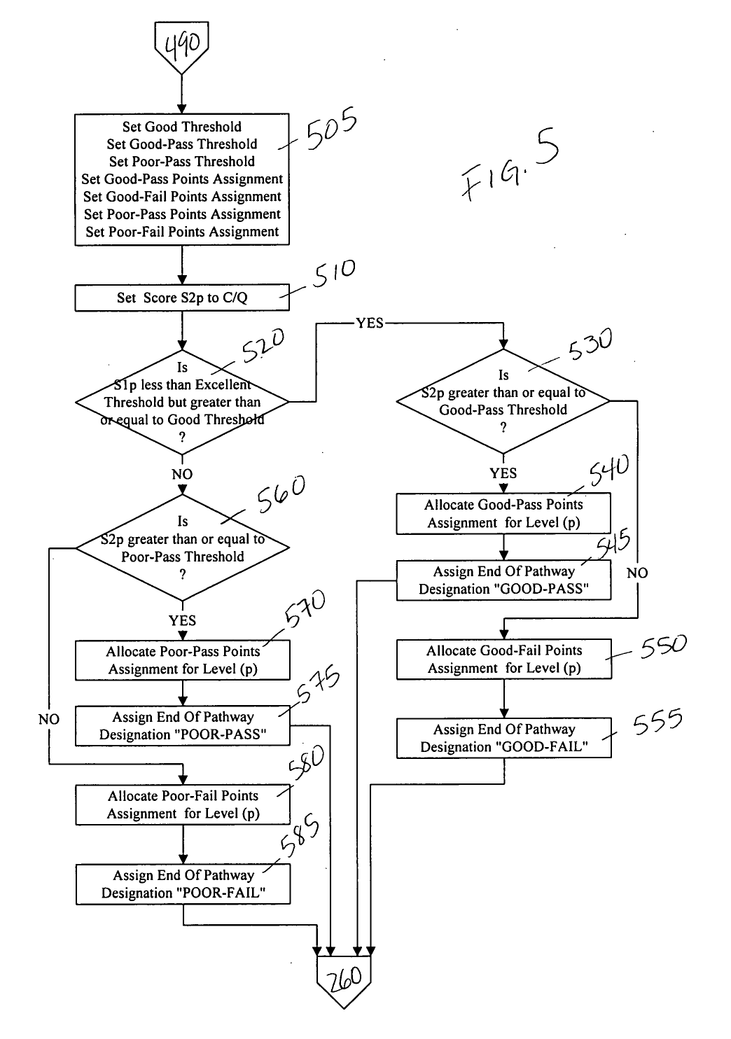

If Applicants' method determines in step 490 that all the questions selected in step 420 have not been propounded, then the method transitions from step 490 to step 450 and continues as described herein. Alternatively, if Applicants' method determines in step 490 that all the questions selected in step 420 have been propounded, then the method transitions from step 490 to step 505 (FIG. 5).

Referring now to FIG. 5, in step 505 Applicants' method sets a Good Threshold. In step 520, Applicants' method determines if the first examination score S1p is greater than or equal to this Good Threshold. In certain embodiments, that Good Threshold is set at 0.67. In other embodiments, that Good Threshold is set to a value greater than 0.67. In still other embodiments, that Good Threshold is set to a value less than 0.67.

Step 505 further comprises setting a Good-Pass Threshold, a Good-Pass Points Assignment, and a Good-Fail Points Assignment. In step 530, Applicants' method optionally determines if the second examination score S2p is greater than or equal to this Good-Pass Threshold. In certain embodiments, that Good Threshold is set at 0.75. In other embodiments, that Good Threshold is set to a value greater than 0.75. In still other embodiments, that Good Threshold is set to a value less than 0.75.

In certain embodiments, the Good-Pass Points Assignment is set to 16 points in step 505. In other embodiments, the Good-Pass Assignment is set a value less than 16 points in step 505. In still other embodiments, the Good-Pass Points Assignment is set to a value greater than 16 points in step 505.

In certain embodiments, the Good-Fail Points Assignment is set to 12 points in step 505. In other embodiments, the Good-Pass Assignment is set a value less than 12 points in step 505. In still other embodiments, the Good-Pass Points Assignment is set to a value greater than 12 points in step 505.

Step 505 further comprises setting a Poor-Pass Threshold, a Poor-Pass Points Assignment, and a Poor-Fail Points Assignment. In step 560, Applicants' method optionally determines if the second examination score S2p is greater than or equal to this Poor-Pass Threshold. In certain embodiments, that Poor Threshold is set at 0.75. In other embodiments, that Good Threshold is set to a value greater than 0.75. In still other embodiments, that Good Threshold is set to a value less than 0.75.

In certain embodiments, the Poor-Pass Points Assignment is set to 8 points in step 505. In other embodiments, the Poor-Pass Assignment is set a value less than 8 points in step 505. In still other embodiments, the Poor-Pass Points Assignment is set to a value greater than 8 points in step 505.

In certain embodiments, the Poor-Fail Points Assignment is set to 4 points in step 505. In other embodiments, the Poor-Pass Assignment is set a value less than 4 points in step 505. In still other embodiments, the Poor-Pass Points Assignment is set to a value greater than 4 points in step 505.

In certain embodiments, step 505 is performed by a natural person. In other embodiments, step 505 is performed by a computing device. Step 505 may be performed at any time before performing steps 520, 530, or 560.

In step 510, Applicants' method calculates a score for the second examination at the (p)th level by dividing the total number of correctly answered questions in step 465 by the number of questions propounded in step 450. In certain embodiments, step 510 comprises setting a score S2p to C/Q. In certain embodiments, step 510 is performed by a natural person. In other embodiments, step 510 is performed by a computing device.

Applicants' method transitions from step 510 to step 520 wherein the method determines if the first score of step 210 is less than the Excellent Threshold but greater than or equal to the Good Threshold. In certain embodiments, step 520 is performed by a natural person. In other embodiments, step 520 is performed by a computing device.

If Applicants' method determines in step 520 that the first score of step 210 is less than the Excellent Threshold but greater than or equal to the Good Threshold, then the method transitions from step 520 to step 530 wherein the method determines if the second score of step 510 is greater than or equal to the Good-Pass Threshold. In certain embodiments, step 530 is performed by a natural person. In other embodiments, step 530 is performed by a computing device.

If Applicants' method determines in step 530 that the second score of step 510 is greater than or equal to the Good-Pass Threshold, then the method transitions from step 530 to step 540 wherein the method allocates the Good-Pass Points Assignment for the (p)th knowledge level. In certain embodiments, step 540 is performed by a natural person. In other embodiments, step 540 is performed by a computing device.

Applicants' method transitions from step 540 to step 545 wherein the method assigns an End Of Pathway designation of GOOD-PASS. In certain embodiments, step 545 is performed by a natural person. In other embodiments, step 545 is performed by a computing device. Applicants' method transitions from step 545 to step 260 and continues as described herein.

If Applicants' method determines in step 530 that the second score of step 510 is not greater than or equal to the Good-Pass Threshold, then the method transitions from step 530 to step 550 wherein the method allocates the Good-Fail Points Assignment for the (p)th knowledge level. In certain embodiments, step 550 is performed by a natural person. In other embodiments, step 550 is performed by a computing device.

Applicants' method transitions from step 550 to step 555 wherein the method assigns an End Of Pathway designation of GOOD-FAIL. In certain embodiments, step 555 is performed by a natural person. In other embodiments, step 555 is performed by a computing device. Applicants' method transitions from step 555 to step 260 and continues as described herein.

If Applicants' method determines in step 520 that the first score of step 210 is not greater than or equal to Good Threshold, then the method transitions from step 520 to step 560 wherein the method determines if the second score of step 510 is greater than or equal to the Poor-Pass Threshold. In certain embodiments, step 560 is performed by a natural person. In other embodiments, step 560 is performed by a computing device.

If Applicants' method determines in step 560 that the second score of step 510 is greater than or equal to the Poor-Pass Threshold, then the method transitions from step 560 to step 570 wherein the method allocates Poor-Pass Points Assignment for the (p)th knowledge level. In certain embodiments, step 570 is performed by a natural person. In other embodiments, step 570 is performed by a computing device.

Applicants' method transitions from step 570 to step 575 wherein the method assigns an End Of Pathway designation of POOR-PASS. In certain embodiments, step 575 is performed by a natural person. In other embodiments, step 575 is performed by a computing device. Applicants' method transitions from step 575 to step 260 and continues as described herein.

If Applicants' method determines in step 560 that the second score of step 510 is not greater than or equal to the Poor-Pass Threshold, then the method transitions from step 560 to step 580 wherein the method allocates Poor-Fail Points Assignment for the (p)th knowledge level. In certain embodiments, step 580 is performed by a natural person. In other embodiments, step 580 is performed by a computing device.

Applicants' method transitions from step 580 to step 585 wherein the method assigns an End Of Pathway designation of POOR-FAIL. In certain embodiments, step 585 is performed by a natural person. In other embodiments, step 585 is performed by a computing device. Applicants' method transitions from step 585 to step 260 and continues as described herein.

The embodiments of Applicants' method recited in FIGS. 1, 2, 3, 4, and/or 5, may be implemented separately. Moreover, in certain embodiments, individual steps recited in FIGS. 1, 2, 3, 4, and/or 5, may be combined, eliminated, or reordered.

In certain embodiments, Applicants' invention includes instructions, such as instructions 616 (FIG. 6A), residing in memory, such as for example information storage medium 614 (FIG. 6A), where those instructions are executed by processor 612 (FIG. 6A) to performs steps 110, 120, 130, 140, 150, 160, 165, 170, 180, and/or 190 recited in FIG. 1, wherein step 165 comprises receiving an answer, and/or steps 205, 210, 220, 230, 240, 250, 260, 270, and/or 280, recited in FIG. 2, wherein step 205 comprises retrieving a pre-determined Excellent Threshold and Excellent Points Assignment, and/or steps 305, 310, 315, 320, 330, 340, 350, 360, and/or 380, recited in FIG. 3, and/or steps 410, 420, 430, 440, 450, 460, 465, 470, 480, and/or 490, recited in FIG. 4, wherein step 465 comprises receiving an answer, and/or steps 505, 510, 520, 530, 540, 545, 550, 555, 560, 570, 575, 580, and/or 585, recited in FIG. 5, wherein step 505 comprises retrieving pre-determined values for a Good Threshold, a Good-Pass Threshold, a Poor-Pass Threshold, a Good-Pass Points Assignment, a Good-Fail Points Assignment, A Poor-Pass Points Assignment, and a Poor-Fail Points Assignment.

In other embodiments, Applicants' invention includes instructions residing in any other computer program product, where those instructions are executed by a computer to perform steps 110, 120, 130, 140, 150, 160, 165, 170, 180, and/or 190 recited in FIG. 1, wherein step 165 comprises receiving an answer, and/or steps 205, 210, 220, 230, 240, 250, 260, 270, and/or 280, recited in FIG. 2, wherein step 205 comprises retrieving a pre-determined Excellent Threshold and Excellent Points Assignment, and/or steps 305, 310, 315, 320, 330, 340, 350, 360, and/or 380, recited in FIG. 3, and/or steps 410, 420, 430, 440, 450, 460, 465, 470, 480, and/or 490, recited in FIG. 4, wherein step 465 comprises receiving an answer, and/or steps 505, 510, 520, 530, 540, 545, 550, 555, 560, 570, 575, 580, and/or 585, recited in FIG. 5, wherein step 505 comprises retrieving pre-determined values for a Good Threshold, a Good-Pass Threshold, a Poor-Pass Threshold, a Good-Pass Points Assignment, a Good-Fail Points Assignment, A Poor-Pass Points Assignment, and a Poor-Fail Points Assignment.

In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

1. A method to assess a person's knowledge of a subject area, comprising the steps of:
preparing a plurality of test questions relating to said subject area;
selecting (n) first test questions from said plurality of test questions, wherein (n) is greater than 1;
propounding each of said first test questions to said person;
answering zero or more of said propounded first test questions by said person;
determining for each of said propounded first test questions if that first test question was correctly answered;
calculating a first score by dividing the number of correctly answered first questions by (n);
setting an Excellent Threshold and an Excellent Points Assignment;
determining if said first score is greater than or equal to said Excellent Threshold;
operative if said first score is greater than or equal to said Excellent Threshold, allocating said Excellent Points Assignment to said person and assigning an End Of Pathway designation of Excellent to said person.

2. The method of claim 1, wherein said first score is not greater than or equal to said Excellent Threshold, further comprising the steps of:
selecting (q) second test questions from said plurality of test questions;
propounding each of said second test questions to said person;
answering zero or more of said propounded second test questions by said person;
determining for each of said propounded second test questions if that second test question was correctly answered;
calculating a second score by dividing the number of correctly answered second questions by (q);
setting a Good Threshold, a Good-Pass Threshold, a Poor-Pass Threshold, a Good-Pass Points Assignment, a Good-Fail Points Assignment, a Poor-Pass Points Assignment, and a Poor-Fail Points Assignment;
operative if said first score is less than said Excellent Threshold but greater than said Good Threshold, and if said second score is greater than or equal to said Good-Pass Threshold, allocating said Good-Pass Points Assignment to said person and assigning an End Of Pathway designation of Good-Pass to said person;
operative if said first score is less than said Excellent Threshold but greater than said Good Threshold, and if said second score is not greater than or equal to said Good-Pass Threshold, allocating said Good-Fail Points Assignment to said person and assigning an End Of Pathway designation of Good-Fail to said person;
operative if said first score is less than said Good Threshold, and if said second score is greater than or equal to Poor-Pass Threshold, allocating said Poor-Pass Points Assignment to said person and assigning an End Of Pathway designation of Poor-Pass to said person; and
operative if said first score is less than said Good Threshold, and if said second score is not greater than or equal to said Poor-Pass Threshold, allocating said Poor-Fail Points Assignment to said person and assigning an End Of Pathway designation of Poor-Fail to said person.

3. The method of claim 2, further comprising the steps of:
defining two or more levels of knowledge for said subject area;
selecting a first level from said two or more levels of knowledge;
performing the steps of claim 1, and optionally the steps of claim 2, for said first selected level; and
performing the steps of claim 1, and optionally the steps of claim 2, for said second selected level.

4. The method of claim 2, further comprising the steps of:
defining two or more categories of knowledge relating to said subject area;
selecting a first category and a second category from said two or more categories;
wherein said selecting (n) first test questions step comprises selecting from said plurality of questions (n1) first test questions relating to said first category and (n2) first test questions relating to said second category;
wherein said calculating steps comprises calculating a first score by dividing the number of correctly answered first questions by (n1+n2).

5. The method of claim 4, further comprising the steps of:
calculating a first category score C1 for said first category by dividing the number of correctly answered first test questions relating to said first category by n1;
calculating a second category score C2 for said second category by dividing the number of correctly answered first test questions relating to said second category by n2;
wherein said step selecting (q) second test questions step comprises selecting q1 second test questions relating to said first category, wherein the value of q1 is based upon the value of C1, and selecting q2 second questions relating to said second category, wherein the value of q2 is based upon the value of C2.

6. The method of claim 4, wherein said calculating a second score step comprises calculating a second score by dividing the number of correctly answered second questions by (q1+q2).

7. The method of claim 2, further comprising the steps of:
providing a computing device comprising a storage medium;
storing said plurality of test questions in said storage medium;
providing an information display device interconnected with said computing device;
providing a data input device interconnected with said computing device;
positioning said information display device such that said person can read first information displayed on said information display device;
positioning said data input device such that said person can provide second information to said computing device using said data input device;
wherein:
said propounding each of said first test questions step further comprises displaying each of said first test questions on said information display device;
said propounding each of said second test questions step further comprises displaying each of said second test questions on said information display device;
said answering zero or more of said first test questions step further comprises providing zero or more answers in response to said first test questions to said computing device by said person using said data input device;
said answering zero or more of said second test questions step further comprises providing zero or more answers in response to said second test questions to said computing device by said person using said data input device.

8. The method of claim 7, further comprising the steps of:
displaying said first score on said information display device substantially synchronously with calculating said first score;
displaying said second score on said information display device substantially synchronously with calculating said second score.

9. The method of claim 7, further comprising:
displaying on said information display device said assigned End Of Pathway designation substantially synchronously with assigning said End Of Pathway designation.

10. An article of manufacture comprising an information storage medium, a plurality of test questions written to said information storage medium, said test questions relating to a subject area, and a computer useable medium having computer readable program code disposed therein to assess a person's knowledge of said subject area, wherein said article of manufacture is interconnected to an information display device and a data input device, the computer readable program code comprising a series of computer readable program steps to effect:
selecting (n) first test questions from said predetermined plurality of test questions, wherein (n) is greater than 1;
displaying each of said first test questions on said information display device;
receiving via said data input device zero or more answers to said first test questions;
determining for each of said displayed first test questions if that first test question was correctly answered;
calculating a first score by dividing the number of correctly answered first questions by (n);
retrieving a pre-determined Excellent Threshold and a pre-determined Excellent Points Assignment;
determining if said first score is greater than or equal to said Excellent Threshold;
operative if said first score is greater than or equal to said Excellent Threshold, allocating said Excellent Points Assignment and assigning an End Of Pathway designation of Excellent.

11. The article of manufacture of claim 10, said computer readable program code further comprising a series of computer readable program steps to effect if said first score is not greater than or equal to said Excellent Threshold:
selecting (q) second test questions from said plurality of test questions;
displaying each of said second test questions on said information display device;
receiving via said data input device zero or more answers to said second test questions;
determining for each of said displayed second test questions if that second test question was correctly answered;
calculating a second score by dividing the number of correctly answered second questions by (q);
retrieving predetermined values for a Good Threshold, a Good-Pass Threshold, a Poor-Pass Threshold, a Good-Pass Points Assignment, a Good-Fail Points Assignment, a Poor-Pass Points Assignment, and a Poor-Fail Points Assignment;
operative if said first score is less than said Excellent Threshold but greater than said Good Threshold, and if said second score is greater than or equal to said Good-Pass Threshold, allocating said Good-Pass Points Assignment to said person and assigning an End Of Pathway designation of Good-Pass to said person;
operative if said first score is less than said Excellent Threshold but greater than said Good Threshold, and if said second score is not greater than or equal to said Good-Pass Threshold, allocating said Good-Fail Points Assignment to said person and assigning an End Of Pathway designation of Good-Fail to said person;
operative if said first score is less than said Good Threshold, and if said second score is greater than or equal to Poor-Pass Threshold, allocating said Poor-Pass Points Assignment to said person and assigning an End Of Pathway designation of Poor-Pass to said person; and
operative if said first score is less than said Good Threshold, and if said second score is not greater than or equal to said Poor-Pass Threshold, allocating said Poor-Fail Points Assignment to said person and assigning an End Of Pathway designation of Poor-Fail to said person.

12. The article of manufacture of claim 11, wherein said plurality of questions comprise one or more questions relating to a first category of knowledge relating to said subject area, and one or more questions relating to a second category of knowledge relating to said subject area, wherein:
said computer readable program code to select (n) first test questions from said predetermined plurality of test questions further comprises a series of computer readable program steps to effect selecting from said plurality of questions (n1) first test questions relating to said first category and (n2) first test questions relating to said second category; and
said computer readable program code to calculate a first score further comprises a series of computer readable program steps to effect calculating a first score by dividing the number of correctly answered first questions by (n1+n2).

13. The article of manufacture of claim 12, said computer readable program code further comprising a series of computer readable program steps to effect:
calculating a first category score C1 for said first category by dividing the number of correctly answered first test questions relating to said first category by n1;
calculating a first category score C2 for said second category by dividing the number of correctly answered first test questions relating to said second category by n2.

14. The article of manufacture of claim 13, said computer readable program code further comprising a series of computer readable program steps to effect:
selecting q1 second questions relating to said first category, wherein the value of q1 is based upon the value of C1; and
selecting q2 second questions relating to said second category, wherein the value of q2 is based upon the value of C2.

15. The article of manufacture of claim 14, wherein said computer readable program code to calculate a second score further comprises a series of computer readable program steps to effect calculating a second score by dividing the number of correctly answered second questions by (q1+q2).

16. A computer program product usable with a programmable computer processor having computer readable program code embodied therein to assess a person's knowledge of said subject area, wherein said programmable computer processor is disposed in a computing device capable of displaying information on an interconnected information display device, and wherein said first computing device is capable of receiving information from an interconnected data input device, comprising:
computer readable program code which causes said programmable computer processor to select (n) first test questions from a predetermined plurality of test questions, wherein (n) is greater than 1;
computer readable program code which causes said programmable computer processor to display each of said first test questions on said information display device;
computer readable program code which causes said programmable computer processor to receive from said data input device zero or more answers in response to said propounded first test questions;
computer readable program code which causes said programmable computer processor to determine for each of said propounded first test questions if that first test question was correctly answered;
computer readable program code which causes said programmable computer processor to calculate a first score by dividing the number of correctly answered first questions by (n);
computer readable program code which causes said programmable computer processor to retrieve a pre-determined Excellent Threshold and a pre-determined Excellent Points Assignment;
computer readable program code which causes said programmable computer processor to determine if said first score is greater than or equal to said Excellent Threshold;
computer readable program code which, if said first score is greater than or equal to said Excellent Threshold, causes said programmable computer processor to allocate said Excellent Points Assignment and assign an End Of Pathway designation of Excellent.

17. The computer program product of claim 16, further comprising:
computer readable program code which causes said programmable computer processor to select (q) second test questions from said plurality of test questions;
computer readable program code which causes said programmable computer processor to display each of said second test questions on said information display device;
computer readable program code which causes said programmable computer processor to receive zero or more answers in response to said propounded second test questions via said data input device;
computer readable program code which causes said programmable computer processor to determine for each of said propounded second test questions if that second test question was correctly answered;
computer readable program code which causes said programmable computer processor to calculate a second score by dividing the number of correctly answered second questions by (q);
computer readable program code which causes said programmable computer processor to retrieve pre-determined values for a Good Threshold, a Good-Pass Threshold, a Poor-Pass Threshold, a Good-Pass Points Assignment, a Good-Fail Points Assignment, a Poor-Pass Points Assignment, and a Poor-Fail Points Assignment;
computer readable program code which, if said first score is less than said Excellent Threshold but greater than said Good Threshold, and if said second score is greater than or equal to said Good-Pass Threshold, causes said programmable computer processor to allocate said Good-Pass Points Assignment and assign an End Of Pathway designation of Good-Pass;
computer readable program code which, if said first score is less than said Excellent Threshold but greater than said Good Threshold, and if said second score is not greater than or equal to said Good-Pass Threshold, causes said programmable computer processor to allocate said Good-Fail Points Assignment and assign an End Of Pathway designation of Good-Fail;
computer readable program code which, if said first score is less than said Good Threshold, and if said second score is greater than or equal to said Poor-Pass Threshold, causes said programmable computer processor to allocate said Poor-Pass Points Assignment and assign an End Of Pathway designation of Poor-Pass; and
computer readable program code which, if said first score is less than said Good Threshold, and if said second score is not greater than or equal to said Poor-Pass Threshold, causes said programmable computer processor to allocate said Poor-Fail Points Assignment and assign an End Of Pathway designation of Poor-Fail.

18. The article of manufacture of claim 16, wherein said plurality of questions comprise one or more questions relating to a first category of knowledge relating to said subject area, and one or more questions relating to a second category of knowledge relating to said subject area, wherein:
said computer readable program code which causes said programmable computer processor to select (n) first test questions from said predetermined plurality of test questions further comprises computer readable program code which causes said programmable computer processor to select from said plurality of questions (n1) first test questions relating to said first category and (n2) first test questions relating to said second category; and
said computer readable program code which causes said programmable computer processor to calculate a first score further comprises computer readable program code which causes said programmable computer processor to calculate a first score by dividing the number of correctly answered first questions by (n1+n2).

19. The article of manufacture of claim 18, further comprising:
computer readable program code which causes said programmable computer processor to calculate a first category score C1 for said first category by dividing the number of correctly answered first test questions relating to said first category by n1;
computer readable program code which causes said programmable computer processor to calculate a second category score C2 for said second category by dividing the number of correctly answered first test questions relating to said second category by n2.

20. The article of manufacture of claim 19, further comprising:
computer readable program code which causes said programmable computer processor to select q1 second questions relating to said first category based upon the value of C1; and
computer readable program code which causes said programmable computer processor to selecting q2 second questions relating to said second category based upon the value of C2.

21. The article of manufacture of claim 20, wherein said computer readable program code which causes said programmable computer processor to calculate a second score further comprises computer readable program code which causes said programmable computer processor to calculate a second score by dividing the number of correctly answered second questions by (q1+q2).
